(19) United States
(12) Patent Application Publication
(10) Pub. No.: US 2007/0277638 A1
(43) Pub. Date: Dec. 6, 2007

(54) Screw Drive with an Antibacklash Mechanism and Method of Preventing Backlash in a Screw Drive

(76) Inventor: William Kirk, Royal Oak, MI (US)

Correspondence Address: JOHN R. BENEFIEL, 525 Lewis Street, BIRMINGHAM, MI, 48009, US

(21) Appl. No.: 11/740,306

(22) Filed: Apr. 26, 2007

Related U.S. Application Data
(60) Provisional application No. 60/795,623, filed on Apr. 27, 2006.

(51) Int. Cl. F16H 1/24

(52) U.S. Cl. 74/424.95; 74/10.85

(57) ABSTRACT

A screw drive with an antibacklash mechanism and method including a pair of nuts rotatably mounted in a housing which are urged to rotate in opposite directions to engage flanks of leadscrew threads with a torsional spring interposed between the two nuts to eliminate backlash. A pivoted control lever has opposite ends engaged with a respective nut so that if either of the nuts rotate slightly, the other nut is also rotated slightly to prevent jamming. Locking cams are also provided to limit the control lever motion when the screw is sufficiently heavily loaded axially sufficiently to overcome the torsional spring by locking the lever to the housing.

### CROSS REFERENCE TO RELATED APPLICATIONS

This application claims the benefit of U.S. provisional application Ser. No. 60/795,623 filed on Apr. 27, 2006.

### BACKGROUND OF THE INVENTION

This invention concerns screw drives such as ball screws or power screws in which a leadscrew is rotated to linearly drive a nut threaded on the leadscrew. For improved accuracy, the amount of lash or clearance between the mating threads of the shaft and nut should be minimized while still allowing free motion between the threads. While such threads can be precisely ground for this purpose, the cost of making high precision threads is a limiting factor, particularly for parts which must be sold at a moderate price.

Thus, various antibacklash mechanisms have been developed to avoid the need for highly precision manufacturing of the threads, such as the mechanisms shown in U.S. Pat. Nos. 2,385,194 and 2,679,168.

A suitable antibacklash mechanism can convert a low tolerance leadscrew and nut drive into a repeatable screw drive at a moderate cost.

Such mechanisms should be simple and not substantially increase the friction in the drive, nor result in any tendency to jam.

While precision ball screws and common threads with antibacklash mechanisms have heretofore been provided, they have been relatively complex and costly to manufacture.

It is an object of the present invention to provide such an antibacklash mechanism which is simple and effective and can be made at a moderate cost.

### SUMMARY OF THE INVENTION

The above recited object as well as other objects which will become apparent upon a reading of the following specification and claims are achieved by an antibacklash mechanism including a pair of spaced apart drive nuts adapted to receive a leadscrew.

Those nuts are urged to rotate in opposite rotative directions as by an interposed torsion spring to move the internal nut threads thereof into engagement with the leadscrew threads to completely eliminate backlash. The two nuts are each mounted on a respective antifriction bearings held in a surrounding common housing to allow slight relative rotation of the nuts therein and to transmit axial motion of the nuts to the housing and thence to a load attached to the housing. The springs thus wedge each nut between the threads and the respective housing bearings to eliminate backlash.

The nuts are each engaged with a respective end of a control lever pivotable about its midpoint. This engagement may be accomplished with a clamping ring installed thereon having a projecting ball portion received in a slot on a respective lever end. When one nut is rotated slightly by frictional engagement with the screw, this motion is transmitted by the control lever to rotate the other nut in the other direction very slightly to relieve any tendency to lock up the two nuts such that the pair of nuts are driven by the shaft without any appreciable backlash.

A pair of locking cams are provided to restrict control lever motion to prevent difficulties encountered when there is substantial axial loading. Each locking cam is pivoted to a respective end of the control lever which each have a finger engaged with a respective one side of a pin held by a mounting plate and pivotably mounting the control lever to the housing at its midpoint.

A radiused end face on each locking cam opposes a radiused surface on the fixed mounting plate with a slight clearance space therebetween.

An elongated slot in the control lever receives the pin which is held centered along the slot with a spring piece having respective arms engaging an outer side of the finger of each locking cam. Upon significant axial loading one nut will tend to be driven with the shaft overcoming the torsional spring acting on the other nut and continued driving of the control lever would cause malfunctioning of the drive. The shifting of the lever in the slot overcoming the centering spring brings the locking cam radiused surface into engagement with the facing surface on the mounting plate establishing a locking engagement of the housing and preventing the control lever from undergoing any further pivoting motion.

### DESCRIPTION OF THE DRAWING FIGURES

FIG. 1 is a side view of a nut assembly received on a segment of a leadscrew shaft with an associated antibacklash mechanism shown in partial section.

FIG. 2 is a top view of the nut assembly received on a segment of the leadscrew.

FIG. 3 is a top view of a lever carrier plate included in the antibacklash mechanism.

FIG. 4 is a side view of the lever carrier plate shown in FIG. 3.

FIG. 5 is a top view of the lever and carrier assembly included in the antibacklash mechanism.

FIG. 6 is a side view in partial section of the lever and carrier assembly shown in FIG. 5.

FIG. 7 is an enlarged top view of the control lever assembly included in the lever and carrier shown in FIGS. 5 and 6.

FIG. 8 is a side view of the lever and carrier assembly shown in FIG. 7.

FIG. 9 is an enlarged top view of a centering spring element included in the antibacklash mechanism shown in FIG. 5.

FIG. 10 is an end view of the centering spring element shown in FIG. 9.

FIG. 11 is a side view of the centering spring element shown in FIGS. 9 and 10.

FIG. 12 is an end view of one of the pair of clamping rings included in the antibacklash mechanism.

FIG. 13 is a diagrammatic representation of the relationship of the major components of the screw drive according to the invention.

FIG. 14 is a diagram of the forces acting on the components shown in FIG. 13 under light axial loading of the screw drive.

FIG. 15 is a view of the diagram shown in FIG. 13 but with a large axial external load applied.

FIG. 16 is a diagram of the forces resulting from the application of the large external load applied.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

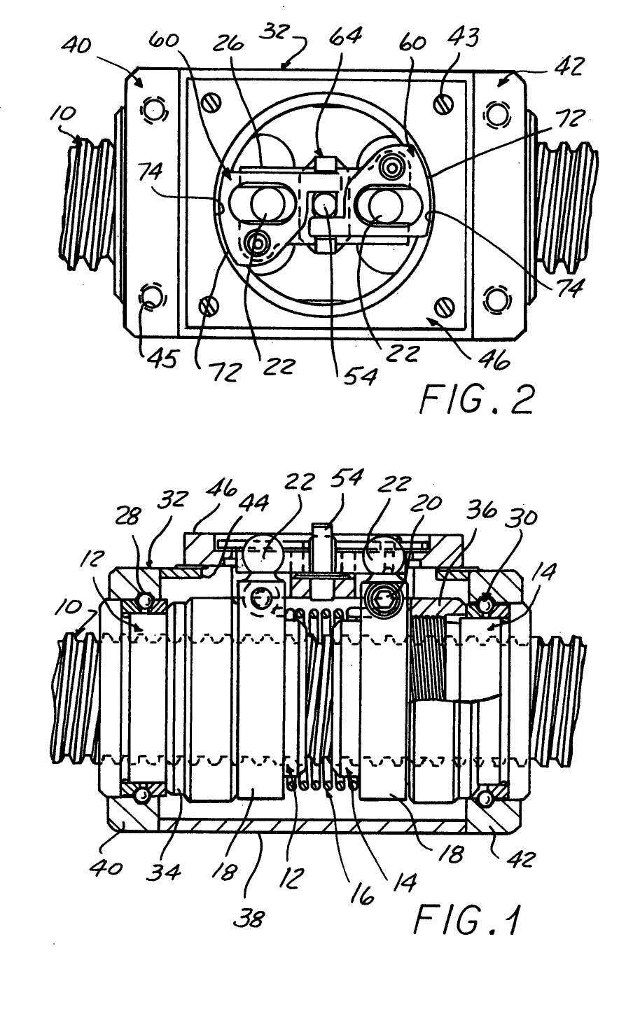

Referring to the drawings and particularly FIGS. 1 and 2, a screw drive is shown including a leadscrew 10 on which are received a pair of drive nuts 12 and 14 which are internally threaded to engage the external threads of the leadscrew 10.

The drive nuts 12 and 14 are separated from each other and are urged to tend to rotate in opposite directions by a helical torsion spring 16 having opposite ends anchored in split clamp rings 18. This causes the threads of each nut 12 and 14 to move into engagement with the threads of the leadscrew 10 eliminating all backlash.

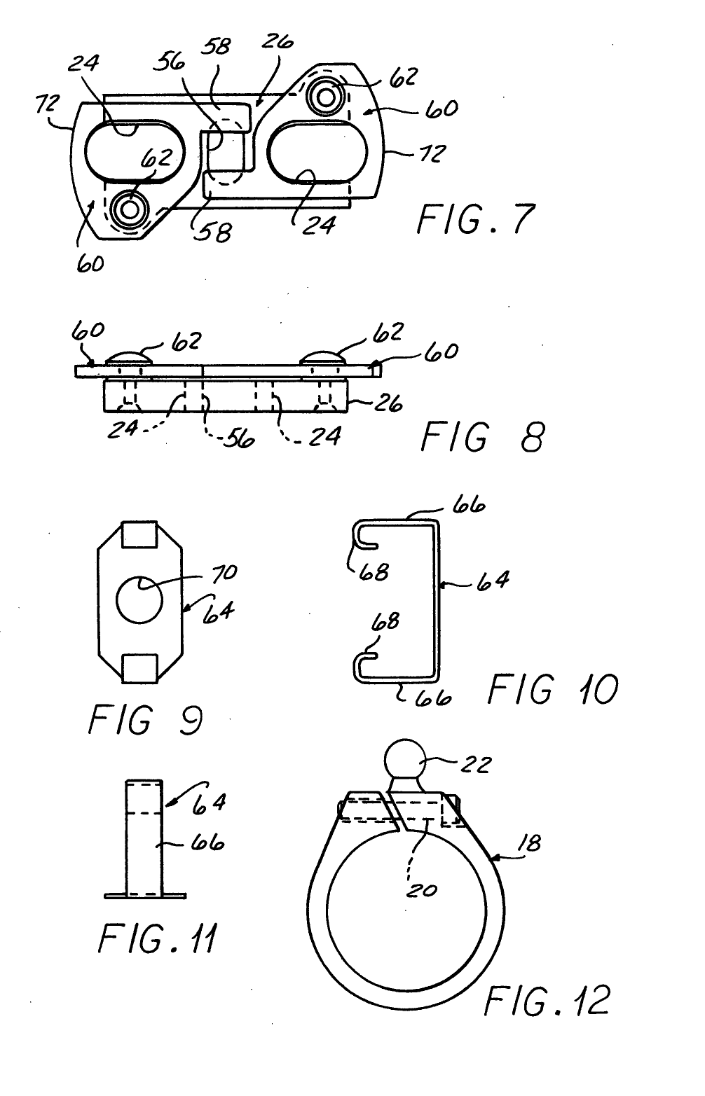

A split clamping ring 18 is tightened onto the exterior of each nut 12 and 14 by means of a screw 20. A ball portion 22 projects upwardly from each clamping ring 18 and is received in a respective slot 24 of a pivoted control lever 26 (FIGS. 7 and 8).

The outer end of each nut 12 and 14 is rotatably supported in a housing elements 40 and 42 an antifriction ball bearing 28, 30, each including a threaded bearing retainer 34 and 36. These bearings axially connect the nuts 12, 14 to the housing 32 to enable an output motion of the housing 32 to be produced when the leadscrew 10 is rotated. The nuts 12, 14 are thus wedged between the thread flanks and the bearings 28, 30 by the spring 16.

A rectangular tube 38 and attached square end pieces 40 and 42 form the housing 32. The top of the housing tube 38 has a opening 44 formed therein.

The end pieces 40, 42 are formed with threaded holes 45 to allow attachment to a driven structure (not shown).

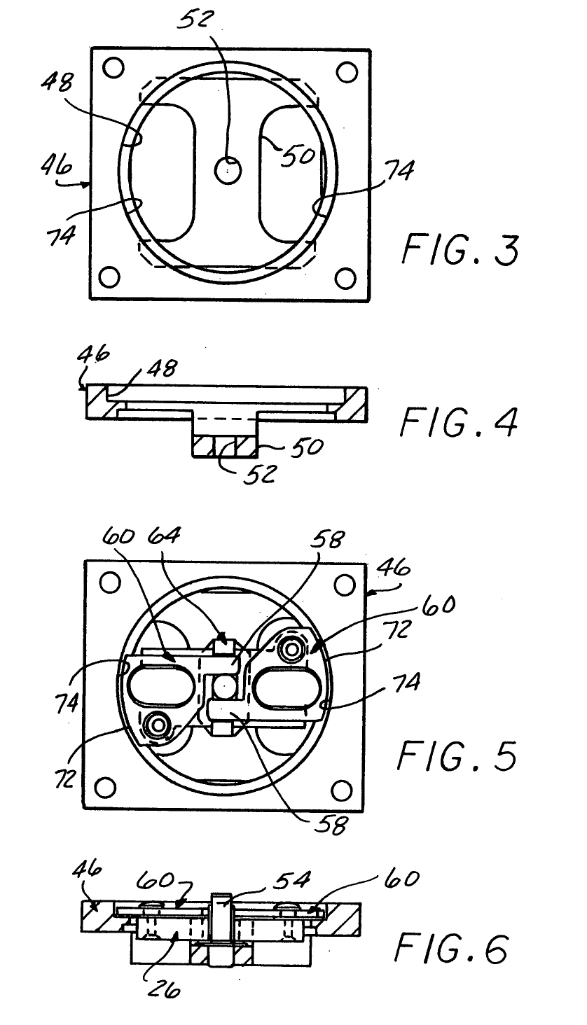

Covering the opening 44 is a rectangular lever carrier plate 46, secured with screws 43 to the housing 34. A counter bore 48 is formed in the center of the plate 46, with an integral bridging portion 50 extending there beneath (FIGS. 3 and 4). A hole 52 (FIG. 3) in the center receives a pivot pin 54 pivotally mounting the control lever 26. The pin 54 is received in a slot 56 (FIG. 7) in the control lever 26. The pin 54 is held centered in the slot 56 by engagement of finger portions 58 of a pair of oppositely directed locking cams 60 each pivoted at their outer ends by rivets 62 acted upon by a centering spring 64 (FIGS. 9, 10 and 11).

The U-shaped centering spring 64 has a pair of arms 66 received over the sides of the control lever 26 with formed over ends 68 engaging the outside of the fingers 58. Thus, a spring force centers the pin 54 in the slot 56 but allows displacement upon development of an axial leadscrew force of a predetermined magnitude. A central hole 70 allows the pin 54 to pass through the spring 64.

The locking cams 60 have an outer radiused surface 72 normally closely spaced inwardly from the outer wall 74 as seen in FIG. 5.

When the leadscrew 10 is rotated, both nuts 12 and 14 will be driven to axially drive the housing 32 and attached load. One of the nuts 12 and 14 will have a slightly greater frictional engagement. The resulting relative motion could cause the two nuts 12, 14 to lockup. In order to avoid this, the control lever 26 is pivoted by the ball 22 of the associated clamping ring 18. This causes the trailing nut 12 or 14 to be advanced slightly to relieve jamming its opposite number.

Upon development of a sufficient axial leadscrew load, one of the nuts 12 or 14 will be driven by the shaft 10 overcoming the spring 16. The locking cams 60 are pivoted by movement of the pin 54 in the slot 56 when one of the nuts 12 or 14 is frictionally driven with the leadscrew 10. This pushes one of the finger portions 58 to rotate a locking cam 60 causing the outer surface 74 to lock the same to the housing 32 and limit the pivoting of the control lever 26.

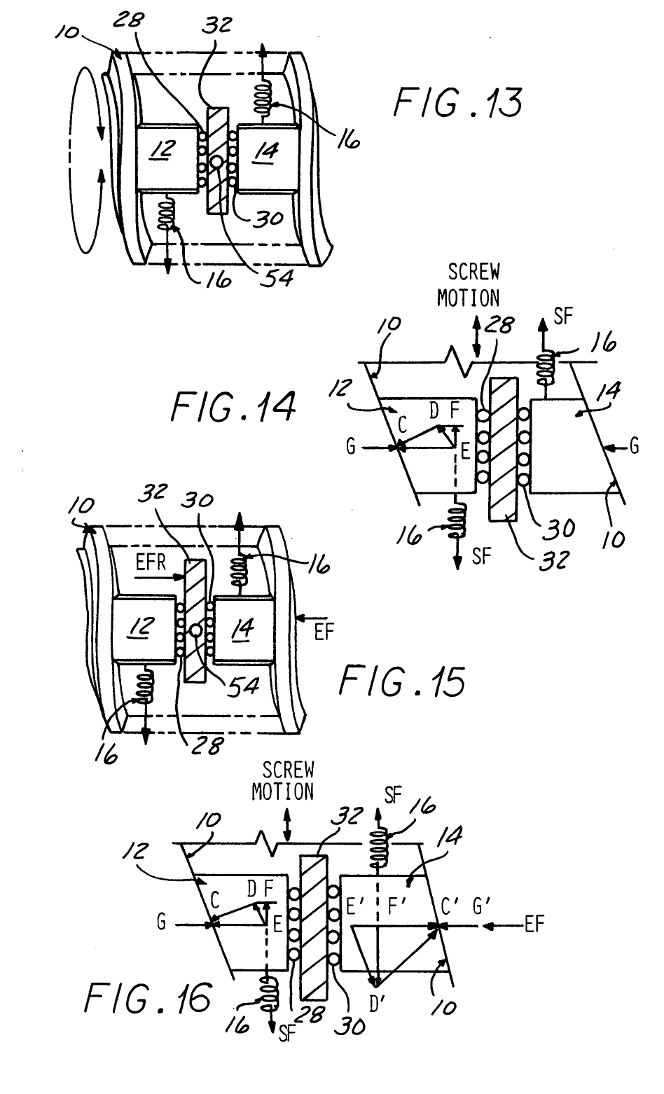

The anti-backlash motion that provides stability and practicality to this invention is based on a balance of forces between the leadscrew and the two leadscrew nuts that form the essence of the concept. The geometry of the design is such that this balance is maintained at all times through the nut interconnecting control lever 26 until heavy axial lead screw forces are introduced. Under these heavy forces, balance continues to be maintained until the spring 16 is forcibly overcome. FIGS. 13-16 illustrate the dynamics of the system, starting with the axially unloaded but rotating leadscrew 10.

FIG. 13 shows diagrammatically two helically formed figures which can be considered a portion of a continuous screw thread on leadscrew 10. The cross-hatched center guide represents the housing 32. The circle superimposed on this cross-hatched figure represents the pin 54. The nuts 12, 14 are able to move vertically, being limited only by the force of the spring, the ball bearings 28, 30 and contact with the leadscrew 10.

FIG. 14 is an idealized representation of FIG. 13, and as such shows an exaggerated thread pitch angle for concept clarity.

FIG. 13 also shows two center targets on the nuts 12, 14. These are representations of pivot points for the control lever 26, not shown. The lever 30 links the two nuts 12, 14 and rotates on the pin 54. Any vertical motion of nut 12 will force nut 14 in the opposite direction and vice versa. The presence of control lever 26 is assumed in all subsequent Figures.

FIG. 14 shows a force diagram for nut 12 that exists when the nut 12 is in contact with the leadscrew 10 thread flank identified on the figure. A similar diagram can be drawn for nut 14, but has not been included for clarity. Both nuts 12, 14 contact a ball bearing 28 or 30 and screw thread 10, which they must do by virtue of the spring forces “SF”. Please note that at all times, the axial forces on each nut 12, 14 must be equal. If these forces were not equal, a compensation force opposing the direction of the larger force must be included. These equal axial forces are generated by the spring 16 shown in FIG. 13, attempting to wedge the nuts 12, 14 between the angled face of the leadscrew 10 and the nut ball bearings 28, 30. This configuration forms a stable static mechanical system. Note that the thread angularity has been amplified for description clarity. In the real situation, these angles are 3.6 degrees (for a ⅝-10 thread), and consequently the wedging action mentioned above is more pronounced than FIG. 13 would suggest.

The vector diagram of FIG. 14 illustrates the forces involved in this antibacklash mechanism. The wedging action caused by spring “SF” introduces opposed nut forces against the screw thread and ball bearings 28, 30. The resulting force “CE” (and the opposite force against the bearings, not shown) is opposed by screw thread force “GC”. This same vector diagram, but inverted, would apply to nut 12, with all forces on nuts 12, 14 and screw 10 in balance.

Note spring force “SF”. This force must be equal to vector “EF”. Vector “DE” is dependent on “EF” and is a force trying to slide the nut along the thread face. It is opposed by frictional effects. On any two surfaces in contact, the frictional force is in general, a percentage of the normal force, in this case vector “CD”. When the surface contact angle is small (in this case 3.6 degrees), the frictional component as related to “CD” would be many times greater than “DE” and “EF” as shown in FIGS. 14 and 16.

This static stability changes when motion is involved, that is, movement of the angular object vertically, as if the leadscrew 10 were in rotary motion. Friction occurs between the screw thread representations and the nuts. If the screw motion is downward, frictional forces for nut 14 tend to pull nut 14 into heavier wedging and higher frictional resistance until lockup occurs. Nut 12 is being pushed downward and away from its thread flank avoiding this wedge effect. By linking the two nuts 12, 14 together with pin-pivoted lever 26, nut 12 can control the wedging tendency of nut 14 and prevent lockup. The same is true of leadscrew motion in the opposite rotation, except nuts 12, 14 exchange roles. This action is effective in eliminating backlash. However, when an external axial load is placed on the leadscrew 10, problems would occur.

Referring now to FIG. 15, which is identical to FIG. 13 except it shows an external axial force EF applied to the leadscrew 10 and resisted by the housing 32 of the anti-backlash mechanism. The housing resistance EFR (FIG. 15) is transferred to nut 14. FIG. 16 shows the resulting vector diagram for nut 14. This vector diagram is made up of the original balance force CG plus the external load EF and results in a much larger vector force diagram (C′D′E′) for nut 14 than for nut 12 (CDE). These larger vector forces are balanced by the EFR so that the force diagram for nut 12 is substantially unchanged and the complete mechanism remains in static balance. Force F′D′ has now dramatically increased and this in turn increases frictional forces for nut 14 proportionately. At some point, these frictional forces become large enough to overcome spring forces SF for both nuts 12 and 14 and nut 14 becomes frictionally engaged with the leadscrew 10 and follows leadscrew motion as if welded. This action completely de-stabilizes the mechanism since leadscrew rotation no longer results in equivalent axial housing motion.

This de-stabilization takes differing forms depending on the direction of external force and the direction of leadscrew rotation. If the external force EF remains unchanged in direction and leadscrew rotation is such that screw motion as shown in FIG. 16 is “down”, the following action takes place. Referring again to FIG. 16 and visualizing the aforementioned lever 26 (FIG. 6) in place and constrained to rotate about the aforementioned pin 54 and further connected to the two nuts 12 and 14 as previously described, it is clear that nut 14 motion as if frictionally locked to the leadscrew, would pull the lever downward. This action must obviously pull nut 12 upward through lever action. When frictional forces overcome spring forces SF on both nuts, the lever 26 then lifts nut 12 out of engagement with the leadscrew 10.

If the external force EF remains unchanged in direction but leadscrew rotation produces screw motion as shown in FIG. 16 as “up”, the following action takes place. Nut 14 moves upward as if again frictionally locked to the leadscrew 10 and pulls pivot lever 26 upward, forcing nut 12 downward. The wedging action on nut 12 increases its frictional force sufficiently to limit, through lever 26, the jamming tendency of nut 14. The higher frictional force on nut 12 expands its force diagram, in effect causing nut 12 to share with nut 14, the resistance to the external load. A balance of forces is thereby maintained to provide load sharing and prevent mechanism lock-up. The load sharing between nuts 12 and 14 creates a penalty of higher overall frictional effect between the leadscrew and the complete nut mechanism. In this case, spring forces SF have minimal effect, but the higher frictional forces tend to displace the pivot lever 26 in its slot.

To correct the de-stabilization problem described above, a mechanism to lock the pivot lever 26 from overcoming spring forces SF, is included in the mechanism.

As previously described, pivot lever 26 has an elongated center hole or slot 56 (FIG. 7), allowing the pivot lever 26 to move linearly as well as rotatively about pin 54 (FIG. 6) but within the confines of the slot 56. FIG. 5 shows cam fingers 58 and spring 64 both of which act to keep the pivot lever 26 normally centered in the slot 56. Forces as described in the paragraphs above could also overcome spring 64, and cause pivot lever 26 to move linearly within slot 56, thereby moving one of the cam fingers 58 (FIG. 5) relative to the pivot lever 26. This action rotates the affected cam 60 about its pivot to cause contact between surfaces 72 and 74, thus effectively preventing further lever rotation and preventing the complete mechanism from destabilization described.

To provide suitable anti-backlash action regardless of screw rotation or external load direction combinations, most features of this invention show mirrored constructs. When the lever-locking feature becomes operable, one or the other but not both of these mirrored constructs may be used. As an example, one or the other of the above-mentioned cams 60 may be activated for locking of the pivot lever 26, but not both simultaneously. When locking occurs, the involved cam 60 no longer rotates with the pivot lever 26 but becomes jammed against the side of the lever carrier plate 46.

Referring to FIG. 2, note that the ball portion 22 of each of the clamps 18 are nearly in line with cam pivots 62 (FIG. 7), in a vertical sense. The pivot lever 26, although constrained from rotating about its center, is not restrained from rotating about pivot 62. It will be obvious from inspection of FIG. 2, that the spherical ball portion 22 closest to the locked cam pivot ceases to influence lever motion due to its close vertical alignment with locked cam pivot 62. However, the remaining ball portion 22 gains substantially increased leverage due to its increased distance from the same pivot 62. This change in relationship of the parts involved causes one of the nuts 12, 14 to gain leverage control over its opposite and can therefore be substantially freed of external load effects to accept the function of backlash control.

All of the actions described above either in normal operation or due to application of external forces, cause minimal spatial movement of the elements involved, nearly undetectable to direct observation. As a result of these very small movements, de-stabilization effects are rendered unimportant and do not in fact degrade the anti-backlash features of the invention.

1. A screw drive corresponding:
a leadscrew;
a pair of separated nuts on said leadscrew, each having internal threads engaged with external threads on said leadscrew;
a spring interengaging said nuts and urging them in opposite rotative directions to engage both nut internal threads with the threads of said leadscrew;
a housing having both of said nuts rotatably supported therein with bearings so as to be axially engaged with said housing;
a control lever pivotally mounted to said housing, said control lever having each end drivingly engaged with a respective nut with a rotary interconnection so that upon slight rotation of one of said nuts by engagement with said leadscrew a slight counter rotation of the other nut is simultaneously carried out by pivoting of said control lever to prevent any jam condition from developing.

2. The screw drive according to claim 1 further including a locking cam on each end of said control lever pivoted upon driving of one of said nuts with said leadscrew to lock said control lever to said housing to prevent pivoting motion.

3. The screw driving according to claim 2 wherein said rotary interconnection of each of said nuts with a respective end of said lever comprises a clamping ring clamped to each nut and having a portion engaging a respective end of said lever.

4. A method of eliminating backlash in a screw drive including a leadscrew comprising engaging said leadscrew threads with a pair of separate internally threaded nuts while biasing said nuts in opposite rotative directions to cause both nuts to be in engagement with said leadscrew's external threads; and
interconnecting both of said nuts with a pivotally mounted control lever to transmit slight rotative movements to each other so as to prevent any jamming conditions during driving of said nuts by rotation of said leadscrew.

5. The method according to claim 4 further including preventing pivoting of said control lever upon driving of either nut by said leadscrew threads so as to prevent rotation of said nut in unison with said leadscrew.

6. The method according to claim 5 including pivotally mounting said control lever to a housing and rotatably mounting said nuts in said housing with antifriction bearings so as to prevent relative axial movement with respect to said housing, and pivotally mounting said control lever on said housing.

7. The method according to claim 6 including locking said control lever to said housing to prevent said pivoting of said control lever.
